(19) United States
(12) Patent Application Publication
(10) Pub. No.: US 2002/0129253 A1
(43) Pub. Date: Sep. 12, 2002

(54) Watermarking a compressed information signal

(76) Inventor: Gerrit Cornelis Langelaar, Eindhoven (NL)

Correspondence Address: U.S. Philips Corporation, 580 White Plains Road, Tarrytown, NY, 10591, US

(21) Appl. No.: 10/056,492

(22) Filed: Jan. 17, 2002

(30) Foreign Application Priority Data
Jan. 23, 2001 (EP) 01200277.0
Dec. 5, 2001 (EP) 01204680.1

(51) Int. Cl. H04L 9/00

(52) U.S. Cl. 713/176

(57) ABSTRACT

A method and arrangement are disclosed for embedding a watermark in an MPEG compressed video stream. The watermark (a spatial noise pattern) is embedded by selectively discarding the smallest quantized DCT coefficients. The discarded coefficients are subsequently merged in the runs of the remaining coefficients. The decision whether a coefficient is discarded or not is made on the basis of a pre-calculated watermark buffer and the number of already discarded coefficients per 8×8 DCT block. The advantages of this method are (i) a very simple bit rate control system and (ii) no need for drift compensation. The algorithm can be implemented in a very efficient manner with respect to memory requirements and computational complexity.

### FIELD OF THE INVENTION

The invention relates to a method of embedding a watermark in an information signal which is compressed so as to include first signal samples having a given first value and further signal samples having a different value. A typical example of such a compressed information signal is an MPEG2 video signal in which video images are represented by transform coefficients, a significant number of which have the first value zero.

### BACKGROUND OF THE INVENTION

A known method of embedding a watermark in a compressed video signal is disclosed in F. Hartung and B. Girod: “Digital Watermarking of MPEG-2 Coded Video in the Bitstream Domain”, published in ICASSP, Vol. 4, 1997, pp. 2621-2624. The watermark is a pseudo-noise sequence in the original signal domain. The watermark is discrete cosine transformed prior to embedding. Non-zero DCT coefficients of the compressed signal are modified by adding thereto the corresponding coefficients of the transformed watermark sequence.

The prior art watermark embedding scheme has some drawbacks. When applied to motion-compensated coding, such as MPEG2, the modification of transform coefficients may propagate in time. Watermarks from previous frames may accumulate in the current frame and result in visual distortion. To avoid this, the prior art watermark embedder requires drift compensation. Moreover, modification of DCT coefficients in an already compressed bit stream affects the bit rate. The prior art embedder therefore checks whether transmission of the watermarked coefficient increases the bit rate, and transmits the original coefficient if that is the case.

### OBJECT AND SUMMARY OF THE INVENTION

It is an object of the invention to provide a method of embedding a watermark which alleviates the above-mentioned drawbacks.

To this end, the method in accordance with the invention is characterized in that the modifying step is applied to signal samples if the modified signal sample assumes the first value due to said modification. It is thereby achieved that the number of signal samples having the first value increases, which generally leads to a lower bit rate. It is not necessary to actually test the impact of a sample modification on the number of bits.

Preferably, the signal samples qualified for modification are samples having the smallest zon-zero value (i.e. MPEG video coefficients being quantized as +1 or −1). As these coefficients represent noise-like information and the changes are very small (±quantization step), drift compensation is not necessary, and the embedded watermark is imperceptible but still detectable.

### BRIEF DESCRIPTION OF THE DRAWINGS

FIG. 1 shows schematically an arrangement for carrying out the method in accordance with the invention.

FIGS. 2A-2C and 3A-3G show diagrams to illustrate the operation of the arrangement which is shown in FIG. 1.

### DESCRIPTION OF A PREFERRED EMBODIMENT

The invention will now be described with reference to an arrangement for embedding a watermark in a video signal which is compressed in accordance with the MPEG2 standard, although the invention is neither restricted to video signals nor to a particular compression standard. Note that the compressed signal may already have an embedded watermark. In that case, an additional watermark is embedded in the signal. This process of watermarking an already watermarked signal is usually referred to as “remarking”.

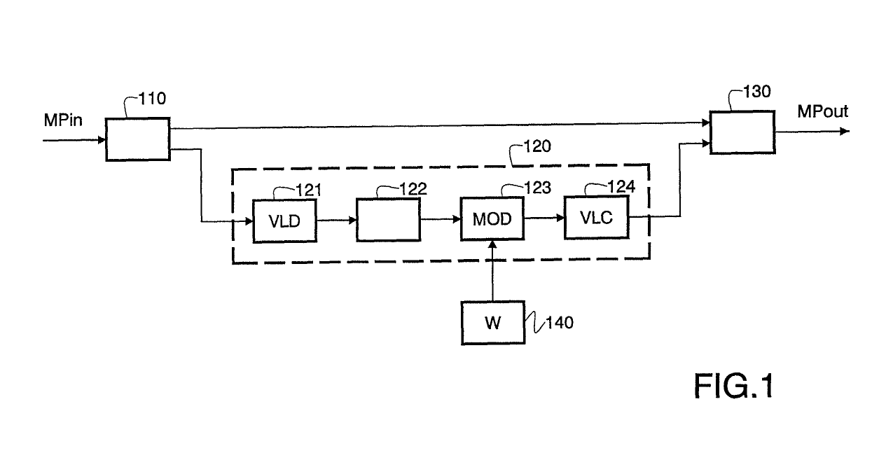

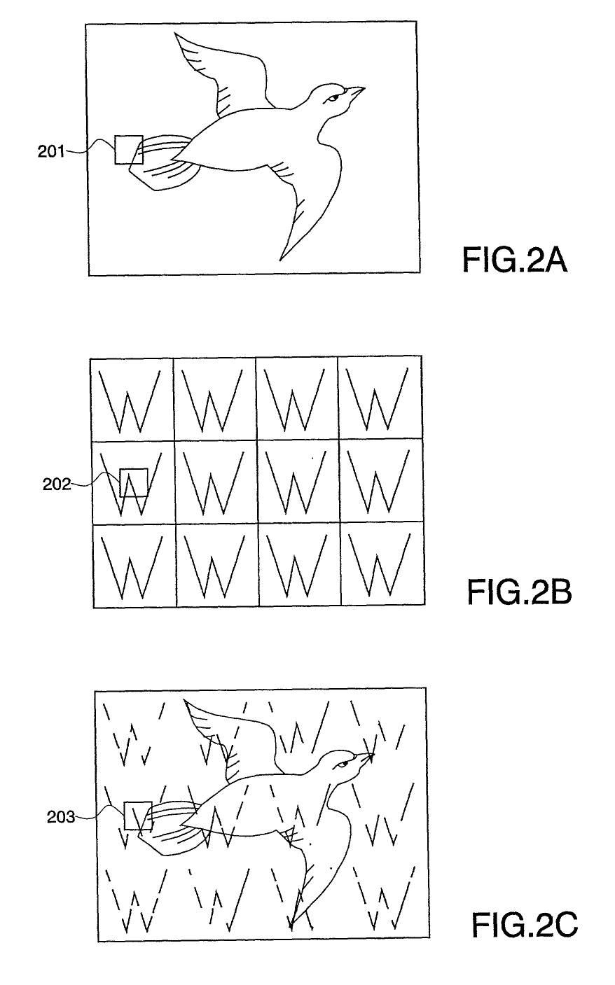

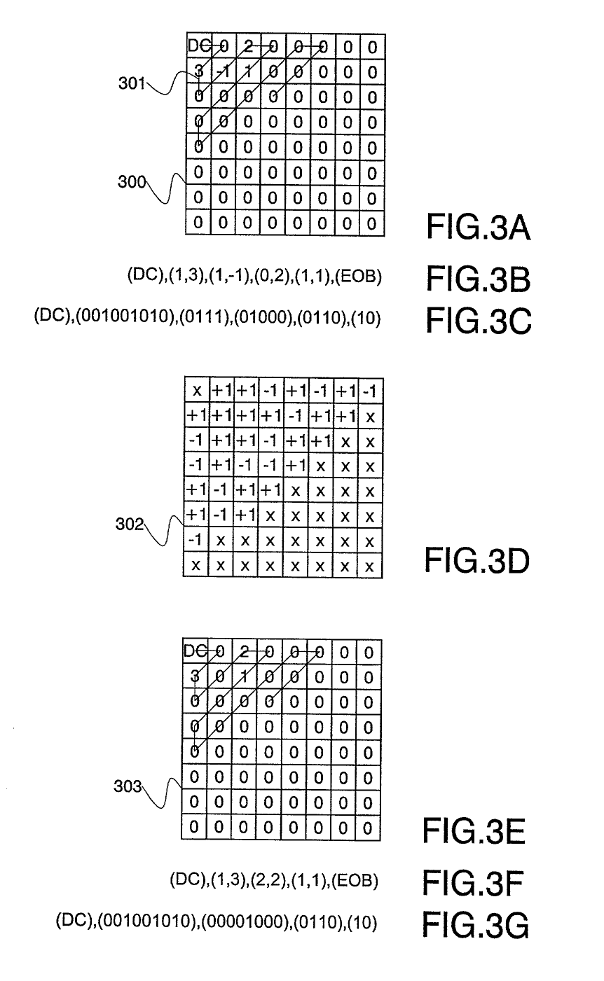

FIG. 1 shows a schematic diagram of an arrangement carrying out the method in accordance with the invention. The arrangement comprises a parsing unit 110, a VLC processing unit 120, an output stage 130, and a watermark buffer 140. Its operation will be described with reference to FIGS. 2A-2C and 3A-3G.

The arrangement receives an MPEG elementary video stream MPin which represents a sequence of video images. One such video image is shown in FIG. 2A by way of illustrative example. The video images are divided into blocks of 8×8 pixels, one of which is denoted 201 in FIG. 2A. The pixel blocks are represented by respective blocks of 8×8 DCT (discrete cosine transform) coefficients. The upper left transform coefficient of such a DCT block represents the average luminance of the corresponding pixel block and is commonly referred to as the DC coefficient. The other coefficients represent spatial frequencies and are referred to as AC coefficients. The upper left AC coefficients represent coarse details of the image, the lower right coefficients represent fine details. The AC coefficients have been quantized. This quantization process causes many AC coefficients of a DCT block to assume the value zero. FIG. 3A shows a typical example of a DCT block 300, corresponding to the pixel block 201 in FIG. 2A.

The coefficients of the DCT block have been sequentially scanned in accordance with a zigzag pattern (301 in FIG. 3A) and variable-length encoded. The variable-length encoding scheme is a combination of Huffman coding and run-length coding. More particularly, each run of zero AC coefficients and a subsequent non-zero AC coefficient constitutes a run-level pair which is encoded into a single variable-length code word. FIG. 3B shows the run-level pairs of the DCT block 300. An End-Of-Block code (EOB) denotes the absence of further non-zero coefficients in the DCT block. FIG. 3C shows the series of variable-length code words representing DCT block 300 as received by the arrangement,

In an MPEG2 elementary video stream, four such DCT luminance blocks and two DCT chrominance blocks constitute a macro block, a number of macro blocks constitutes a slice, a number of slices constitutes a picture (field or frame), and a series of pictures constitutes a video sequence. Some pictures are autonomously encoded (I-pictures), other pictures are predictively encoded with motion compensation (P- and B-pictures). In the latter case, the DCT coefficients represent differences between pixels of the current picture and pixels of a reference picture rather than the pixels themselves.

The MPEG2 elementary video stream MPin is applied to the parsing unit 110 (FIG. 1). This parsing unit partially interprets the MPEG bit stream and splits the stream into variable-length code words representing luminance DCT coefficients (hereinafter: VLCs) and other MPEG codes. The unit also gathers information such as the coordinates of the blocks, the coding type (field or frame), the scan type (zigzag or alternate). The VLCs and associated information are applied to the VLC processing unit 120. The other MPEG codes are directly applied to the output stage 130.

The watermark to be embedded is a pseudo-random noise sequence in the spatial domain. In this embodiment of the arrangement, a 128×128 basic watermark pattern is “tiled” over the extent of the image. This operation is illustrated in FIG. 2B. The 128×128 basic pseudo-random watermark pattern is herein represented by a symbol W for better visualization.

The spatial pixel values of the basic watermark are transformed to the same representation as the video content in the MPEG stream. To this end, the 128×128 basic watermark pattern is divided into 8×8 blocks, one of which is denoted 202 in FIG. 2B. The blocks are discrete cosine transformed and quantized. Note that the transform and quantizing operation needs to be done only once. The DCT coefficients thus calculated are stored in the 128×128 watermark buffer 140 of the arrangement.

The watermark buffer 140 is connected to the VLC processing unit 120, in which the actual embedding of the watermark takes place. The VLC processing unit decodes (121) selected variable-length code words representing the video image into run-level pairs, and converts (122) the series of run-level pairs into a two-dimensional array of 8×8 DCT coefficients. The watermark is embedded, in a modification stage 123, by adding to each video DCT block the spatially corresponding watermark DCT block. The DCT block representing watermark block 202 in FIG. 2B is thus added to the DCT block representing image block 201 in FIG. 2A. However, in accordance with a preferred embodiment of the invention, only DCT coefficients that are turned into zero coefficients by this operation are selected for the purpose of watermarking. For example, the AC coefficient having the value 2 in FIG. 3A will be modified only if the corresponding watermark coefficient has the value −2. In mathematical notation:

if cᵢₙ(i,j)+w(i,j)=0

then cₒᵤₜ(i,j)=0

else cₒᵤₜ(i,j)=cᵢₙ(i,j)

where cᵢₙ is a coefficient of a video DCT block, w is a coefficient of the spatially corresponding watermark DCT block, and cₒᵤₜ is a coefficient of the watermarked video DCT block.

It will be appreciated that the number of zero coefficients in the DCT block is increased by this operation, so that the watermarked video DCT block can be more efficiently encoded than the original DCT block. This is particularly the case for MPEG compressed signals, because the new zero coefficient will be included in the run of another run-level pair (run merge). The re-encoding is performed by a variable-length encoder 124 (FIG. 1). The watermarked block is applied to the output stage 130, which regenerates the MPEG stream by copying the MPEG codes provided by the parsing unit 110 and inserting regenerated VLCs provided by the VLC processing unit 120. Furthermore, the output stage 130 may insert stuffing bits to make the output bit rate equal to the original video bit rate.

In an advantageous embodiment of the invention, only the signs of the DCT coefficients of the watermark pattern are stored in the watermark buffer 140, so that the buffer stores +1 and −1 values only. This reduces the memory capacity of the buffer to 1 bit per coefficient (128×128 bits in total). Moreover, experiments have shown that it is sufficient to apply watermark embedding to the most significant DCT coefficients only (the most significant coefficients are the ones occurring first in the zigzag scan). This reduces the memory requirements even further. FIG. 3D shows a typical example of a watermark DCT block 302 corresponding to the spatial watermark block 202 in FIG. 2B.

FIG. 3E shows a watermarked video DCT block 303 obtained by addition of watermark DCT block 302 to video DCT block 300. In this specific example, one of the non-zero coefficients (the one with the value −1 in FIG. 3A) is turned into a zero coefficient, because the spatially corresponding watermark coefficient has the value +1. FIG. 3F shows the run-level pairs of the watermarked DCT block. Note that the former run-level pairs (1,−1) and (0,2) have been replaced by one run-level pair (2,2). FIG. 3G shows the corresponding output bit stream. The run merge operation appears to save one bit in this example.

FIG. 2C shows the watermarked image represented by the output signal MPout of the arrangement. The pixel block denoted 203 in this Figure corresponds to the watermarked video DCT block 303 in FIG. 3E. As has been attempted to express in FIG. 2C, the amount of watermark embedding varies from tile to tile and from block to block.

In the example described above, only the smallest coefficients (+1 and −1) are qualified for modification. This circumvents the need for drift compensation and renders the watermark imperceptible, in particular if the number of coefficients that is modified is bound to a given maximum (for example, 3).

It is to be noted that the watermark coefficient values +1 and −1 in the embodiment described above may also be assigned to mean the direction (positive and negative, respectively) in which the corresponding image coefficient is to be modified. For example, it may be prescribed that a given range of negative DCT coefficients (for example, −2 and −1) are turned into zeroes by the watermark coefficient value +1, whereas a range of positive DCT coefficients (for example, +2 and +1) are turned into zeroes by watermark coefficient value −1.

It should further be noted that an MPEG2 elementary video stream may include field-coded DCT blocks and frame-coded DCT blocks. In accordance therewith, the watermark buffer 140 may be arranged to contain two watermark patterns, one for field-coded blocks and one for frame-coded blocks. The pattern being used for embedding the watermark is then selected by the field/frame selection identification signal accommodated in the input video stream.

In the above described arrangement for embedding a watermark in an MPEG encoded signal, the “level” part of run-level pairs is changed. However, a level is not an actual value of an AC coefficient, but a quantized version thereof. For example, the run-level pair (1,−1) in FIG. 3B may in fact represent a coefficient X=−104. In another block, the same pair (1,−1) may represent a coefficient X=−6, depending on the quantizer step size. Needless to say that the effect of turning an AC coefficient from −104 into 0 will generally have a different effect on the perceptibility of the embedded watermark than turning the same AC coefficient from −6 into 0.

There may thus be a need to control the watermark embedding process such that the effect thereof on visibility is reduced. To this end, a further embodiment of the embedding method includes the step of controlling the number and/or positions of coefficients being modified in dependence upon the quantizer step size.

In an MPEG decoder, inverse quantization is achieved by multiplying the received level x(n) with the quantizer step size. The quantizer step size is controlled by a weighting matrix W(n) which modifies the step size within a block and a scale factor QS which modifies the step size from (macro-)block to (macro-)block. The following equation specifies MPEG's arithmetic to reconstruct an AC coefficient X(n) from the decoded level x(n):

X(n)=x(n)×W(n)×QS

where n denotes the index in order of the zigzag scan.

There are various ways to generate an upper bound for the number of coefficients that are allowed to be modified. In one embodiment, a level x(n) may only be modified if the corresponding quantizing step size Q(n)=W(n)×QS is less than a predetermined threshold. Different thresholds may thereby be used for different positions in a DCT block (i.e. for different indexes n).

In another embodiment, the maximum number N of coefficients that are allowed to be modified in a block is a function of the quantizer scale factor QS such that N decreases as QS increases. The feasibility of this embodiment can easily be understood if one realizes that the scale factor in fact indicates how strong a DCT block has been quantized. The larger the scale factor, i.e. the larger the quantization step size, the fewer coefficients may be changed in order to render the effect imperceptible. An example of such a function is:

$$N = \frac{c}{Q S}$$

where c is a given constant value.

The quantizer scale factor QS is accommodated in MPEG bit streams as a combination of a parameter quantizer_scale_code and a parameter q_scale_type. The parameter quantizer_scale_code is a 5-bit code. The parameter q_scale_type indicates whether said code represents a linear range of QS-values between 2 and 62, or an exponential range of values between 1 and 112. In both cases, the code is indicative for the step size. Accordingly, the term QS in the above-mentioned function may also be replaced by the parameter quantizer_scale_code.

It is also advantageous to control the positions of the coefficients being modified by the watermark process in dependence upon the quantizer step size. The larger the quantizer step size, the later in the zigzag scan the desired modifications are carried out. This leaves the low-frequency coefficients unaffected and restricts the visibility of the watermark embedding process to the higher frequency coefficients.

The feature of controlling the maximum number and/or the positions of modifiable coefficients in dependence upon the quantizer step size requires only a minor modification of the arrangement. Such a modification can easily be carried out by a skilled person and is therefore not shown.

A method and arrangement are disclosed for embedding a watermark in an MPEG compressed video stream. The watermark (a spatial noise pattern) is embedded by selectively discarding the smallest quantized DCT coefficients. The discarded coefficients are subsequently merged in the runs of the remaining coefficients. The decision whether a coefficient is discarded or not is made on the basis of a pre-calculated watermark buffer and the number of already discarded coefficients per 8×8 DCT block. The advantages of this method are (i) a very simple bit rate control system and (ii) no need for drift compensation. The algorithm can be implemented in a very efficient manner with respect to memory requirements and computational complexity.

1. A method of embedding a watermark in an information signal which is compressed so as to include first signal samples having a given first value and further signal samples having a different value, the method comprising the step of modifying signal samples in accordance with a watermark pattern, characterized in that said modifying step is applied to signal samples if the modified signal sample assumes the first value due to said modification.

2. The method as claimed in claim 1, wherein the first value is zero and the signal samples qualified for modification are signal samples having the smallest non-zero value.

3. The method as claimed in claim 1, wherein the signal samples have been quantized with a quantizer step size, and the signal samples qualified for modification are signal samples being quantized with a step size which is less than a predetermined threshold.

4. The method as claimed in claim 1, wherein the information signal is divided into sections and the number of signal samples qualified for modification is limited to a predetermined maximum per section.

5. A method as claimed in claim 4, wherein the signal samples of a section have been quantized in accordance with a quantizer step scale, the method including the step of controlling said maximum of modified signal samples in dependence upon said quantizer step scale.

6. A method as claimed in claim 1, wherein the information signal is divided into sections and the signal samples of a section have been quantized in accordance with a quantizer step scale, the method including the step of controlling the positions of the signal samples qualified for modification within a section in dependence upon said quantizer step scale.

7. The method as claimed in any one of claims 1-6, wherein the compressed signal includes variable-length code words each identifying a run of first signal samples and a subsequent or preceding further signal sample, the method further comprising the steps of:
decoding the variable-length code words into respective first and further signal samples prior to said modifying step;
merging the modified signal sample with succeeding or preceding first signal samples to obtain a new run of first signal samples, and
encoding the new run of first signal samples and a subsequent or preceding further signal sample into a new variable-length code word.

8. An arrangement for embedding a watermark in an information signal which is compressed so as to include first signal samples having a given first value and further signal samples having a different value, the arrangement comprising means for modifying signal samples in accordance with a watermark pattern, characterized in that the modifying means are arranged to modify signal samples if the modified signal sample assumes the first value due to said modification.
